(19) United States
(12) Patent Application Publication
(10) Pub. No.: US 2025/0377514 A1
(43) Pub. Date: Dec. 11, 2025

(54) COMPACT TELECOMMUNICATION ENCLOSURE WITH HARDENED CONNECTOR PORTS

(71) Applicant: CommScope Technologies LLC, Hickory, NC (US)

(72) Inventors: Patrick Jacques Ann DIEPSTRATEN, Heusden-Zolder (BE); Johan GEENS, Bunsbeek (BE); Bart Mattie CLAESSENS, Hasselt (BE); Philippe COENEGRACHT, Hasselt (BE)

(73) Assignee: CommScope Technologies LLC, Hickory, NC (US)

(21) Appl. No.: 18/875,777

(22) PCT Filed: Jun. 15, 2023
(86) PCT No.: PCT/US2023/068530

§ 371 Date: Dec. 17, 2024

Related U.S. Application Data
(60) Provisional application No. 63/353,463, filed on Jun. 17, 2022.

(51) Int. Cl. G02B 6/44

(52) U.S. Cl. CPC G02B 6/44465

(57) ABSTRACT

A fiber optic arrangement including fiber optic cable passed through a telecommunication enclosure. The telecommunication enclosure includes a housing sealed for outdoor environmental use. At least one fiber optic adapter is carried with the housing. The fiber optic adapter includes a ferrule alignment sleeve having an outer end for receiving a ferrule of a hardened connector inserted to the fiber optic adapter from outside the housing through an exterior connector port. An inner connector mounting locations corresponding to an inner end of the ferrule alignment sleeve. An inner connector is installed at the inner connector mounting location with a ferrule of the inner connector received within the inner end of the ferrule alignment sleeve. The fiber optic cable has optical fibers that are retractable within the fiber optic cable. At least one optical fiber of the fiber optic cable is cut at a cable access location outside the telecommunication enclosure, retracted back to the interior of the telecommunication enclosure, and coupled to the inner fiber optic connector.

### CROSS-REFERENCE TO RELATED APPLICATION(S)

This application is being filed on Jun. 15, 2023, as a PCT International application and claims the benefit of and priority to U.S. Provisional Application Ser. No. 63/353,463, filed Jun. 17, 2022, the disclosure of which is hereby incorporated by reference in its entirety.

### BACKGROUND

Fiber optic telecommunications technology is becoming more prevalent as service providers strive to deliver higher bandwidth communication capabilities to customers/subscribers. As data transmissions increase, the fiber optic network is being extended closer to the end user which can be a premise, business, or a private residence.

As telecommunication cables are routed across data networks, it is necessary to periodically open the cable so that one or more telecommunication lines therein may be spliced, thereby allowing data to be distributed to other cables or “branches” of the telecommunication network. At each point where a telecommunication cable is opened, it is necessary to provide a telecommunications enclosure to protect the exposed interior of the cable. The cable branches may be further distributed until the network reaches individual homes, businesses, offices, and so on. These networks are often referred to as fiber to the premise (FTTP) or fiber to the home (FTTH) networks.

In an FTTH network, telecommunication enclosures are often incorporated throughout the network to facilitate distributing optical service to subscriber locations. The telecommunication enclosures are often near the outer edge of the network and can be environmentally sealed for outdoor environments. The telecommunication enclosures can include outside accessible hardened connector ports for allowing fiber optic cables such as drop cables to be optically connected to the optical fibers of distribution cables routed to or through the telecommunication enclosures.

PCT Publication No. WO 2016/071394 and US Patent Publication No. 2010/0027954 disclose telecommunication enclosures that are environmentally sealed and that include outside accessible hardened connector ports. These types of enclosures are configured such that distribution cables (i.e., feeder cables) can be routed through the enclosures. The portion of a distribution cable routed through a given enclosure has the outer jacket stripped away to expose inner buffer tubes containing the optical fibers. The inner buffer tubes are arranged in a looped configuration within the enclosure with the loops providing sufficient fiber length for optical fibers accessed from the fiber optic cable within the enclosure to be routed within the enclosure and optically spiced (e.g., fusion spliced) to other optical fibers within the enclosure.

### SUMMARY

Aspects of the present disclosure relate to a fiber optic arrangement including fiber optic cable passed through a telecommunication enclosure. The telecommunication enclosure includes a housing sealed for outdoor environmental use. At least one fiber optic adapter is carried with the housing. The fiber optic adapter includes a ferrule alignment sleeve having an outer end for receiving a ferrule of a hardened connector inserted to the fiber optic adapter from outside the housing through an exterior connector port. An inner connector mounting location corresponds to an inner end of the ferrule alignment sleeve. An inner connector is installed at the inner connector mounting location with a ferrule of the inner connector received within the inner end of the ferrule alignment sleeve. The fiber optic cable has optical fibers that are retractable within the fiber optic cable. At least one optical fiber of the fiber optic cable is cut at a cable access location outside the telecommunication enclosure, retracted back to the interior of the telecommunication enclosure, and coupled to the inner fiber optic connector. Because the optical fiber is accessed from outside the enclosure and retracted back (i.e., slid back, pulled back, etc.) into the enclosure through the cable, sufficient fiber length is provided in the enclosure for the optical fiber to be coupled to the inner fiber optic connector (e.g., directly terminated to the inner fiber optic connector or optically spliced to an optical pigtail of the inner fiber optic connector) without requiring a buffer tube or buffer tubes of the fiber optic cable to be arranged in a looped configuration within the telecommunication enclosure. Instead, the buffer tube or buffer tubes of the fiber optic cable can be passed straight through the telecommunication enclosure. This allows the telecommunication enclosure to be configured in a significantly more compact configuration as compared to if sufficient space is required to be provided within the telecommunication enclosure for accommodating routing of the buffer tube or tubes in the looped configuration within the telecommunication enclosure. In certain examples, the telecommunication enclosure is configured for wall mount applications such as facade applications.

These and other features and advantages will be apparent from a reading of the following detailed description and a review of the associated drawings. A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### BRIEF DESCRIPTION OF THE DRAWINGS

FIG. 1 depicts a fiber optic arrangement and fiber distribution architecture in accordance with the principles of the present disclosure.

FIG. 2 schematically depicts an example telecommunication enclosure of the arrangement of FIG. 1 prior to an optical fiber of a distribution cable passed through the telecommunication enclosure being cut and retracted back to the telecommunication enclosure.

FIG. 3 schematically depicts the telecommunication enclosure of FIG. 2 with the optical fiber of the distribution cable retracted back and optically coupled to an inner connector of the telecommunication enclosure that is aligned with a hardened external connector port of the telecommunication enclosure.

FIG. 4 schematically depicts the telecommunication enclosure of FIG. 3 with an additional fiber retracted back to the telecommunication enclosure and spliced to an optical fiber of a cable such as a drop cable routed into the enclosure through a sealed cable port.

FIG. 5 schematically depicts the telecommunication enclosure of FIG. 3 with an additional fiber retracted back to the telecommunication enclosure and spliced to a first connectorized pigtail that is patched to a second connectorized pigtail spliced to an optical fiber of a cable such as a drop cable.

FIG. 6 schematically depicts the telecommunication enclosure of FIG. 3 with an additional fiber retracted back to the telecommunication enclosure and spliced to a first connectorized pigtail that is patched to a connectorized end of a cable such as a drop cable routed into the telecommunication enclosure through a sealed cable port.

FIG. 7 is a rear perspective view of a telecommunication enclosure in accordance with the principles of the present disclosure, the telecommunication enclosure is depicted in a closed configuration.

FIG. 8 is a front perspective view of the telecommunication enclosure of FIG. 7.

FIG. 9 depicts the telecommunication enclosure of FIGS. 7 and 8 in an open configuration.

FIG. 10 depicts the telecommunication enclosure of FIGS. 7 and 8 in an open configuration with an inner fiber management tray assembly removed.

FIG. 11 is a perspective view depicted an interior of a cover of the telecommunication enclosure of FIG. 7.

FIG. 12 is a perspective view of a base and fiber management tray assembly of the telecommunication enclosure of FIG. 7 with fiber management spools installed within the base.

FIG. 13 is a perspective view of a base and fiber management tray assembly of the telecommunication enclosure of FIG. 7 with a first patching arrangement installed within the base.

FIG. 14 is a perspective view of a base and fiber management tray assembly of the telecommunication enclosure of FIG. 7 with a second patching arrangement installed within the base.

FIG. 15 is a perspective view of the telecommunication enclosure of FIG. 7 in the open configuration and further depicted fiber routing between the fiber management tray assembly and inner fiber optic connectors installed in alignment with exterior hardened connector ports on the cover of the telecommunication enclosure.

FIG. 16 is another perspective view of the telecommunication enclosure showing the fiber routing of FIG. 15.

FIG. 17 is an exterior perspective view of an example demateable optical connection interface suitable for use with telecommunication enclosure in accordance with the principles of the present disclosure, the demateable optical connection interface incudes a hardened connector port.

FIG. 18 is an interior perspective view of the demateable optical connection interface of FIG. 17.

FIG. 19 is an exploded view of the demateable optical connection interface of FIG. 17.

FIG. 20 is a longitudinal cross-sectional view of the demateable optical connection interface of FIG. 17 with an inner connector installed within an inner connector mounting location of the interface.

FIG. 21 is a perspective view of a drop cable terminated by a hardened optical connector adapted to be received within the hardened connector portion of the demateable optical connection interface of FIG. 17.

FIG. 22 is a longitudinal cross-sectional view of the hardened optical connector of FIG. 21.

FIG. 23 depicts another example demateable optical connection interface suitable for use with telecommunication enclosure in accordance with the principles of the present disclosure, the demateable optical connection interface incudes a hardened connector port.

FIG. 24 is a partial cross-sectional view of the demateable optical connection interface of FIG. 23.

### DETAILED DESCRIPTION

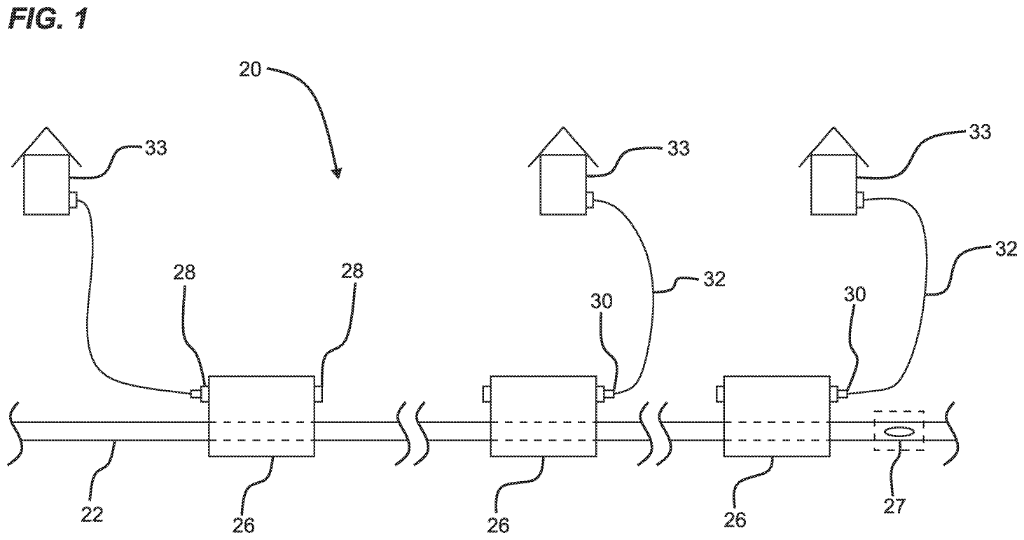

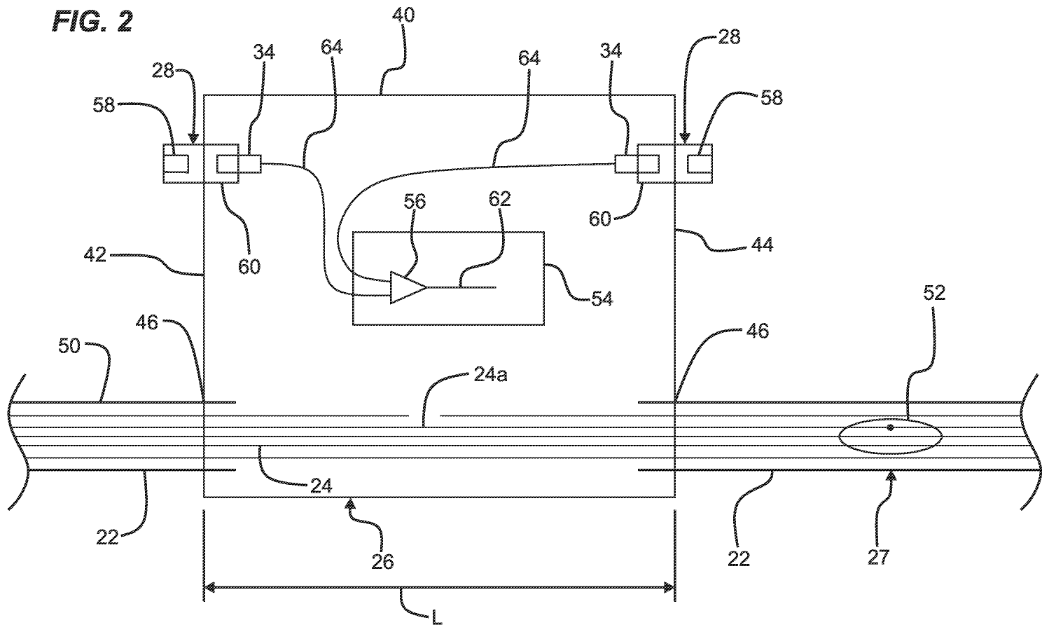

FIG. 1 depicts a fiber optic arrangement in accordance with the principles of the present disclosure for enabling a fiber optic architecture 20 in accordance with the principles of the present disclosure. The fiber optic architecture 20 includes a fiber optic cable 22 (e.g., a fiber distribution cable) having a plurality of optical fibers 24 (see FIG. 2) that are retractable within the fiber optic cable 22. The fiber optic architecture 20 also includes a plurality of telecommunication enclosures 26 through which the fiber optic cable 22 is routed. The telecommunication enclosures 26 can each include at least one demateable optical connection interface 28 and preferably a plurality of the demateable optical connection interfaces 28. Each of the demateable optical connection interfaces 28 includes an exterior hardened connector port for receiving a hardened connector 30 from outside the telecommunication enclosures 26. In certain examples, the hardened connector 30 can terminate the end of a fiber optic cable such as a drop cable 32 for providing optical service to a subscriber location 33. In one example, the telecommunication enclosures 26 can be mounted on the exterior walls of buildings (e.g., the building façade) and the subscriber locations can be residences or businesses in the buildings. Selected ones of the optical fibers 24 can be accessed within the cable 22 at a cable access location 27 located outside (e.g., downstream of) the telecommunication enclosures 26. The selected one of the optical fibers 24 can be cut at the cable access location 27 and retracted back to the telecommunication enclosures 26. At the telecommunication enclosures 26, the selected optical fibers 24 can be coupled to inner fiber optic connectors 34 (see FIG. 2) within the telecommunication enclosures 26 that correspond to the demateable optical connection interfaces 28. The length of optical fiber retracted from the cable 22 from the access location 27 provides sufficient fiber length within the telecommunication enclosures 26 to allow for routing of the fibers 24 on fiber management trays and for fiber splicing (e.g., fusion splicing or mechanical splicing) of the fibers 24 to other fibers within the telecommunication enclosures 26. By retracting the fibers from within the cable 22 to acquire extra fiber length within the enclosures 26, it is not necessary to loop buffer tubes of the cable 22 within the enclosures 26. Consequently, the enclosures 26 can have a more compact configuration as compared to enclosures designed to accommodate looping of buffer tubes within the enclosures. In certain examples, enclosures in accordance with the principles of the present disclosure can be configured to not accommodate internal containment of a buffer tube in a looped configuration whether it be because the enclosures are too compact or because the enclosures simply lack a configuration that can accommodate looping of a buffer tube.

The optical fibers 24 can be accessed outside the enclosures 26 in a variety of ways. For example, in some cases separate cable access locations 27 can be provided for each enclosure 26. In other examples, one cable access location 27 can service multiple enclosures. In certain examples, the cable access location can be an intermediate location along the length of the cable 22 (e.g., a mid-span location) where a portion of the cable jacket is cut and/or removed (e.g., a window cut or the jacket can be stripped between ring cuts) to allow access to optical fibers typically contained within one or more buffer tubes (e.g., loose buffer tubes) within the cable jacket. The buffer tubes 48 can also be cut (e.g., with a window cut) to allow access to the fibers. Once accessed, selected ones of the fibers can be cut to allow retraction of the selected optical fibers back through the cable (e.g., within their corresponding buffer tubes) back to the appropriate enclosure. Once the selected optical fibers have been accessed and cut at the access location, the access location can be sealed. Example cable sealing structures are disclosed by PCT International Publication No. WO2019/197665 which is hereby incorporated by reference in its entirety. In other examples, the cable access location may be a downstream end of the cable which may be contained within a telecommunication enclosure. In other examples, the cable access location of a first telecommunication enclosure can be located within a downstream second telecommunication enclosure.

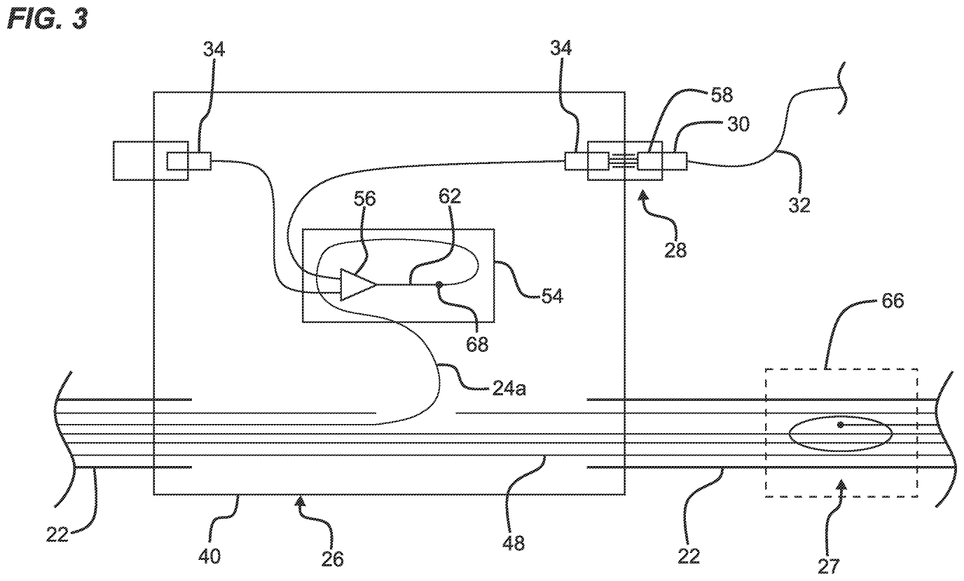

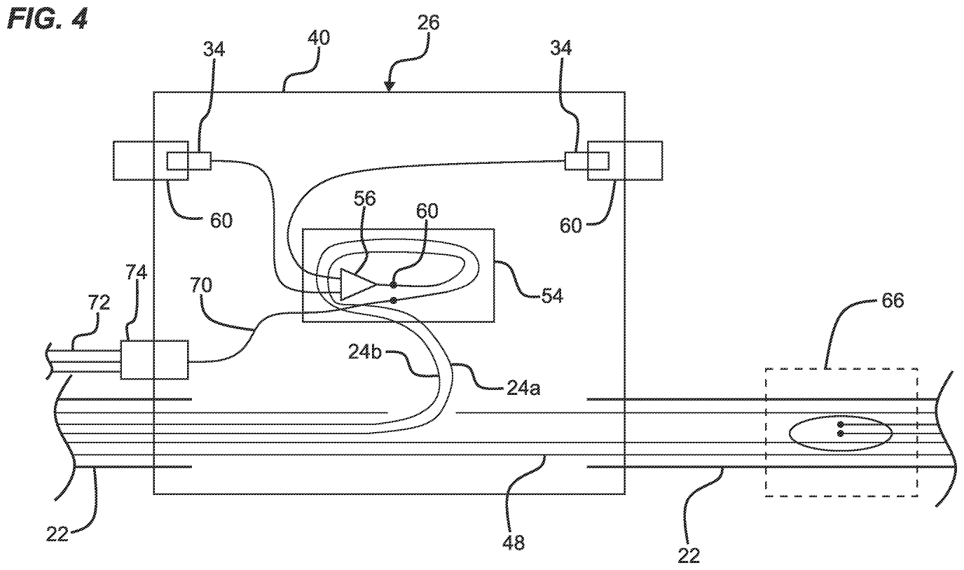

As indicated above, the fiber optic cable 22 is passed through the telecommunication enclosures 26. Within the telecommunication enclosures 26, a portion of the jacket of the cable is removed (e.g., via a window cut, a section of jacket stripped between ring cuts, etc.) to access one or more buffer tubes 48 within the cable. The accessed buffer tube can be cut at a location within the enclosure to access one or more of the optical fibers within the buffer tube that have been accessed and cut at the downstream cable access location 27. The accessed optical fiber can be grasped and pulled to retract the fiber from the access location 27 back into the telecommunication enclosure 26. While one or more buffer tubes 48 of the cable are incised within each of the enclosures 26 to access the optical fibers within the buffer tubes, the buffer tubes are not required to be looped within the enclosures 26, but instead can pass through the enclosures without looping. FIGS. 3 and 4 show example schematics with buffer tubes 48.

In certain examples, the fiber optic cable 22 can include at least two, four, six, eight, twelve, sixteen, twenty-four, twenty-six, forty-eight, ninety-six, or more optical fibers. In one example, fiber optic cable 22 can have twelve to forty-eight fibers; however, alternative implementations may include fewer or more fibers. The fiber optic cable 22 can include one or more buffer tubes 48 for containing the optical fibers within the fiber optic cable. The one or more buffer tubes 48 can be contained within an outer jacket of the cable 22. The optical fibers can be loosely contained within the one or more buffer tubes to facilitate retraction. The fiber optic cable can also include one or more strength structures. Example strength structures can include flexible yarn-type strength structures such as Aramid yarn or more rigid strength members such as fiber glass reinforced polymeric rods.

Referring to FIG. 2, the telecommunication enclosure 26 includes a housing 40 having a first end 42 and an opposite second end 44. The housing 40 can be sealed for outdoor environmental use. The housing 40 is depicted including cable pass-through ports 46 at the first and second ends 42, 44 for routing the cable 22 through the housing 40 in a direction extending along a length L of the housing 40. The cable pass-through ports 46 can include cable seals (e.g., gel seals, rubber seals, silicone seals, etc.) for sealing the entry and exit locations of the cable 22 with respect to the housing 40. A jacket 50 of the cable 22 is removed within the housing 40 to allow a selected one of the optical fibers 24a to be accessed within the housing 40. An access opening 52 (e.g., a window cut) is shown cut through the jacket 50 at the access location 27 for allowing access to the selected optical fiber 24a. The telecommunication enclosure 26 includes a fiber management tray 54 within the housing 40. The fiber management tray 54 is shown supporting a passive optical power splitter 56. In certain examples, the passive optical splitter 56 has a split ratio of 1X2, 1X4, 1X8, 1X12, 1X16 or higher. Other split ratios may be used as well. As depicted, at least one of the demateable optical connection interfaces 28 is provided at each of the housing ends 42, 44. In a preferred example, a plurality of the demateable optical connection interfaces 28 (e.g., at least two, four, six, or eight) is provided at each of the housing ends 42, 44. Each of the demateable optical connection interfaces 28 includes an external hardened connector port 58 accessible from outside the housing 40 and inner connector mounting locations 60 for receiving the inner fiber optic connectors 34. The passive optical power splitter 56 includes an input optical fiber 62 and output optical fibers 64. The inner fiber optic connectors 34 (e.g., SC connectors, LC connectors, or simplified connectors that may include only ferrules supported in hubs) terminate free ends of the output optical fibers 64 and are shown plugged into the inner connector mounting locations 60.

FIG. 3 shows the selected optical fiber 24a cut at the access location 27 and retracted back into the housing 40 of the enclosure 26. The access location 27 is shown sealed by a sealing structure 66 (e.g., a wrap, over-mold, closure, or other structure). The retracted optical fiber 24a is shown spliced to the input optical fiber 62 of the passive optical power splitter 56 at a splice location 68 supported on the fiber management tray 54. One of the drop cables 32 is shown optically connected to the optical fiber 24a through a demateable optical connection provided at the demateable optical connection interface 28 between the hardened connector 30 of the drop cable 32 (which is inserted in the corresponding hardened connector port 58 from outside the housing 40) and the corresponding inner fiber optic connector 34.

FIG. 4 shows the telecommunication enclosure 26 with a second selected optical fiber 24b cut at the access location 27 and retracted back into the housing 40 of the enclosure 26. The retracted second optical fiber 24b is shown spliced to an optical fiber 70 of a cable such as a drop cable 72 routed through one of the ends 42, 44 of the housing 40 through a cable port 74 (e.g., a drop cable port). Cable ports 74 can be provided at each of the ends 42, 44 of the housing 40. The cable ports 74 can include cable seals such as gel seals, rubbers seals, silicone seals, or the like for sealing the locations the cables are routed into the housing 40.

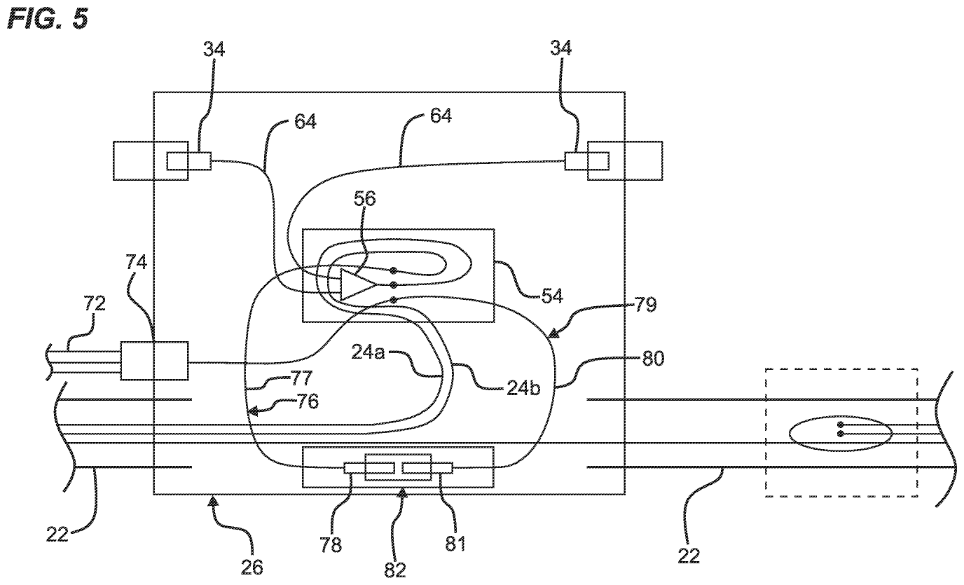

FIG. 5 shows the telecommunication enclosure 26 with the second selected optical fiber 24b spliced to a first optical pigtail 76 having an optical fiber 77 terminated at one end by a first patching fiber optic connector 78 (e.g., an SC or LC connector). The drop cable 72 is shown spliced to a second optical pigtail 79 having an optical fiber 80 terminated at one end by a second patching fiber optic connector 81 (e.g., an SC or LC fiber optic connector). The splices are shown supported at the fiber management tray 54. The patching connectors 78, 81 are shown coupled together at a patch location 82. The patch location 82 can include one or more fiber optic adapters configured for optically coupling fiber optic connectors together. At the patch location 82, the drop cable 72 is demateably optically connected to the second optical fiber 24b.

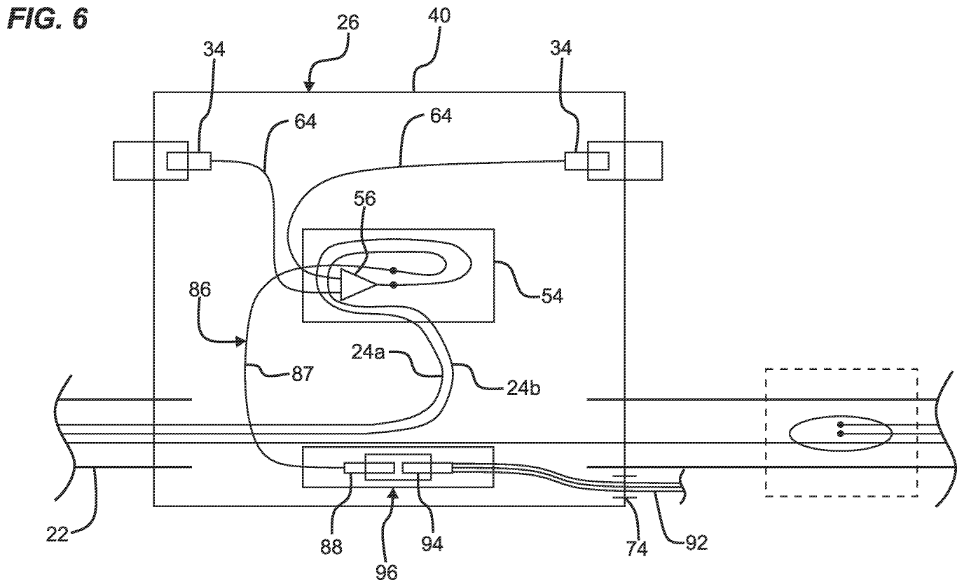

FIG. 6 shows the telecommunication enclosure 26 with the second selected optical fiber 24b spliced to a first optical pigtail 86 having an optical fiber 87 terminated at one end by a first patching fiber optic connector 88 (e.g., an SC or LC connector). A drop cable 92 is shown entering the housing 40 through one of the cable ports 74 at the second end 44 of the housing 40. An end of the drop cable 92 is terminated by a non-hardened connector 94 (e.g., an SC or LC connector). The connectors 88, 94 are shown coupled together at a patch location 96. The patch location 96 can include one or more fiber optic adapters configured for optically coupling fiber optic connectors together. At the patch location 96, the drop cable 92 is demateably optically connected to the second optical fiber 24b.

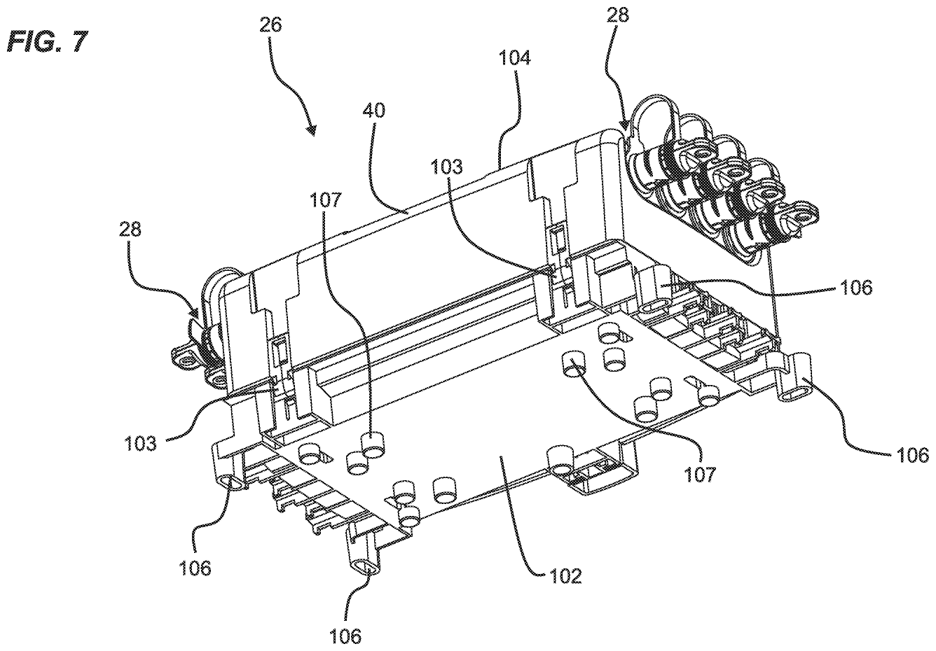

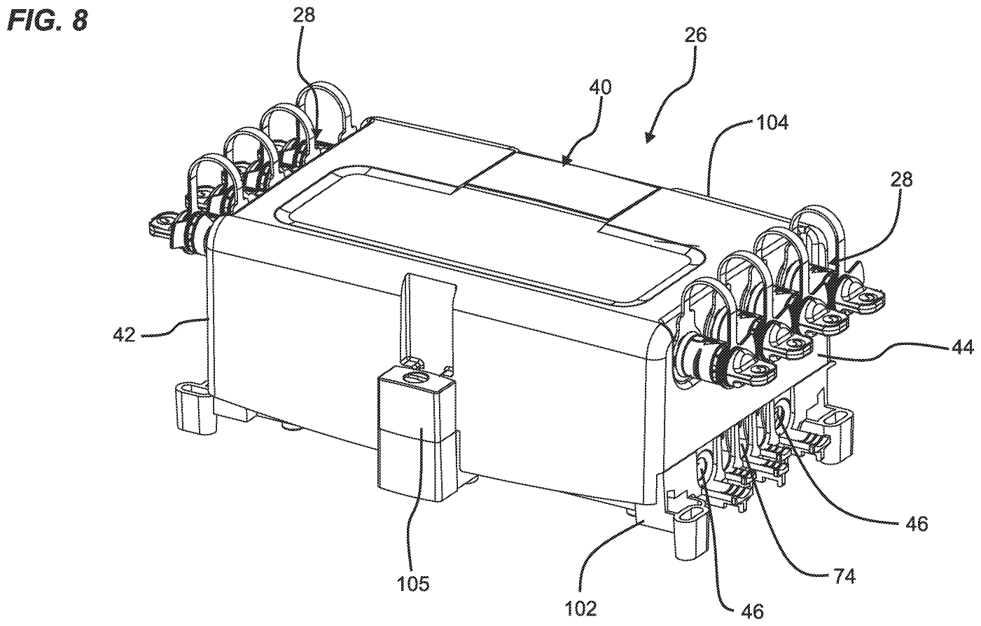

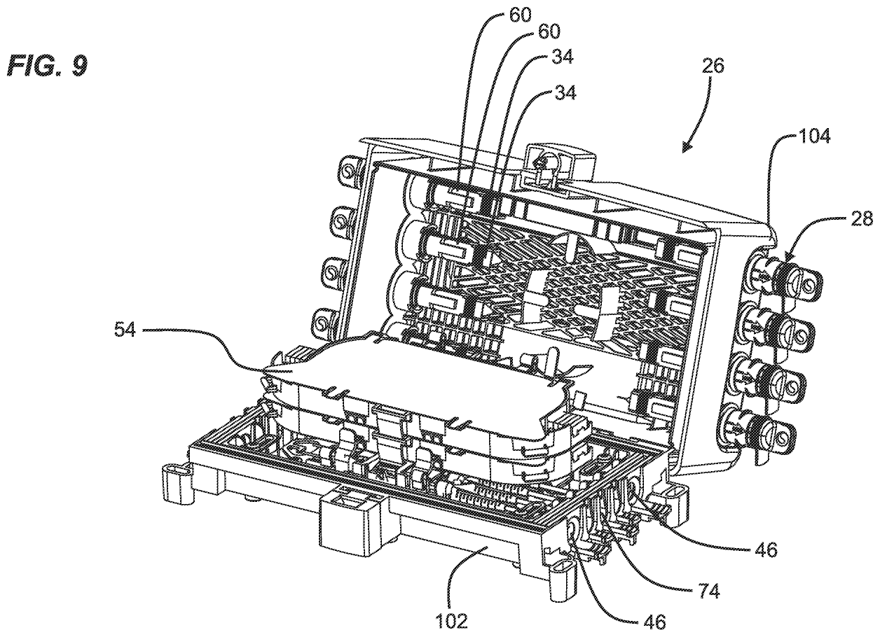

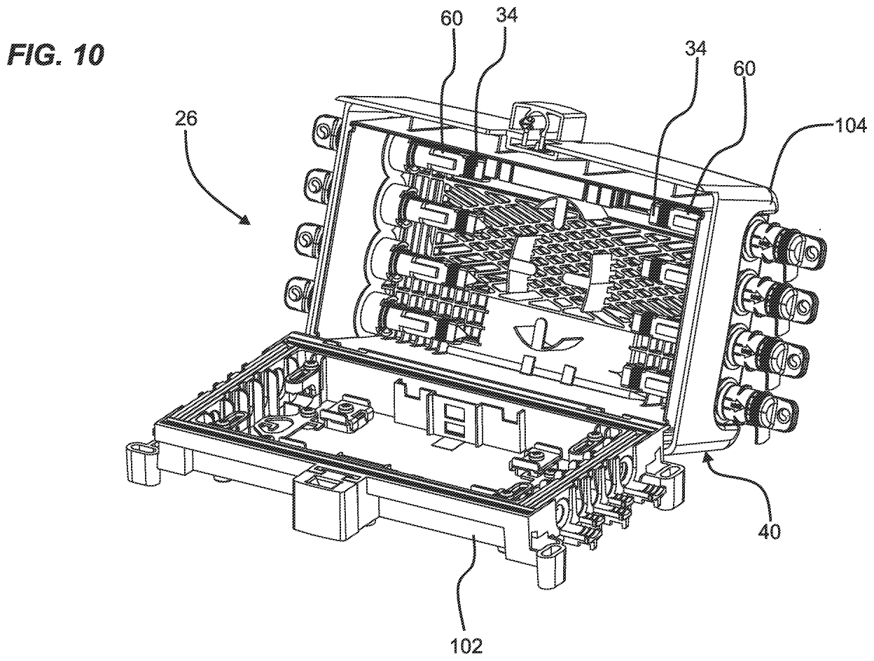

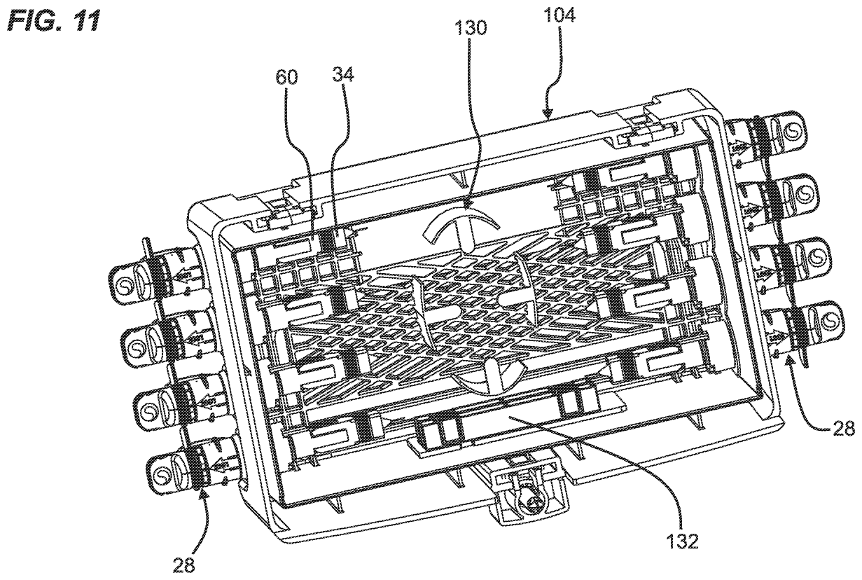

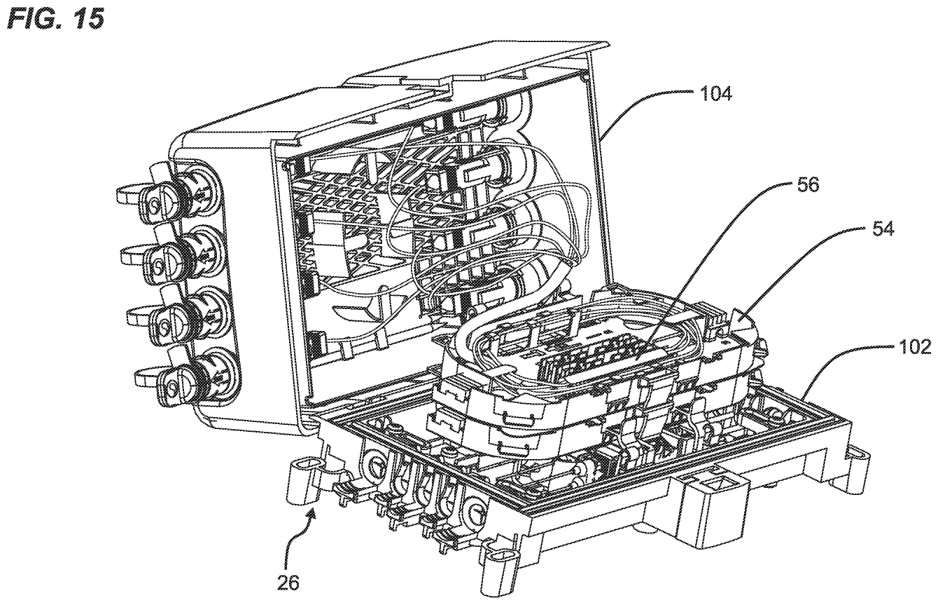

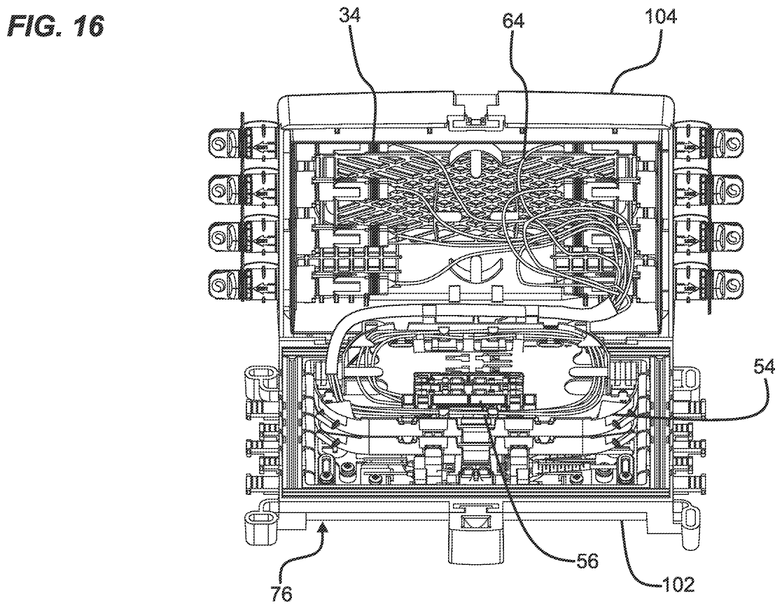

FIGS. 7-16 depict an example configuration for the telecommunication enclosure 26. As depicted, the housing 40 includes a base 102 and a cover 104. In one example, the base 102 and the cover 104 are movable relative to one another between a closed position (see FIGS. 7 and 8) and an open position (see FIGS. 9, 15 and 16). In one example, the base 102 and the cover 104 are pivotally connected to each other by a hinge 103 that allows movement of the housing 40 between the open and closed positions. The hinge 103 can define a pivot axis that extends along the length of the housing 40. A latch 105 can be provided at an opposite side from the hinge 103 for latching the housing 40 in the closed position. In one example, the hinge 103 is at a top of the housing 40 and the latch 105 is at a bottom of the housing 40 when the housing 40 is mounted with the length oriented in a horizontal orientation.

The base 102 can define a back of the housing 40 and can be adapted to be secured to a structure such as a wall. As depicted, the base 102 includes fixation structures 106 (e.g., bosses, flanges, tabs, etc.) at corners of the base 102 defining fastener openings for receiving fasteners (e.g., screws, nails, etc.) used to secure the base 102 to a desired structure such as a wall. Rear mounting stabilization posts 107 project from the base side of the base 102. The cover 104 defines a front of the housing 40. As depicted, the cover 104 has a depth that is at least two or three times as large as a depth of the base 102. A plurality of the demateable optical connection interfaces 28 (e.g., four) is provided at each of the ends 42, 44 of the housing 40. Also, a plurality of the cable pass-through ports 46 (e.g., two) is provided at each of the first and second ends 42, 44 of the housing 40 and a plurality of the drop cable ports 74 (e.g., three) is provided at each of the first and second ends 42, 44 of the housing 40. The demateable optical connection interfaces 28 are provided at the cover 104 and the ports 46, 74 are defined at the base 102.

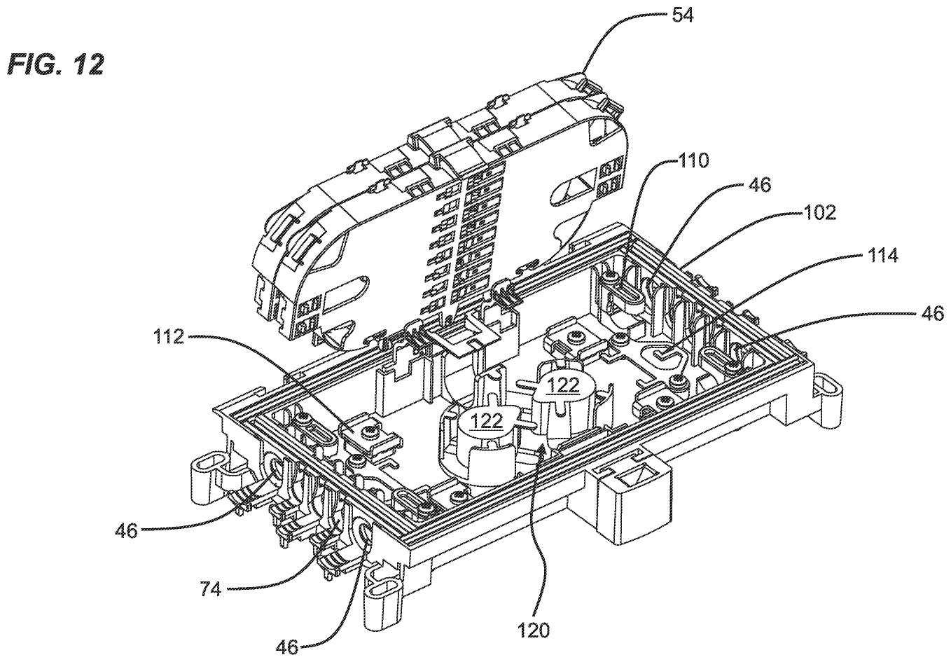

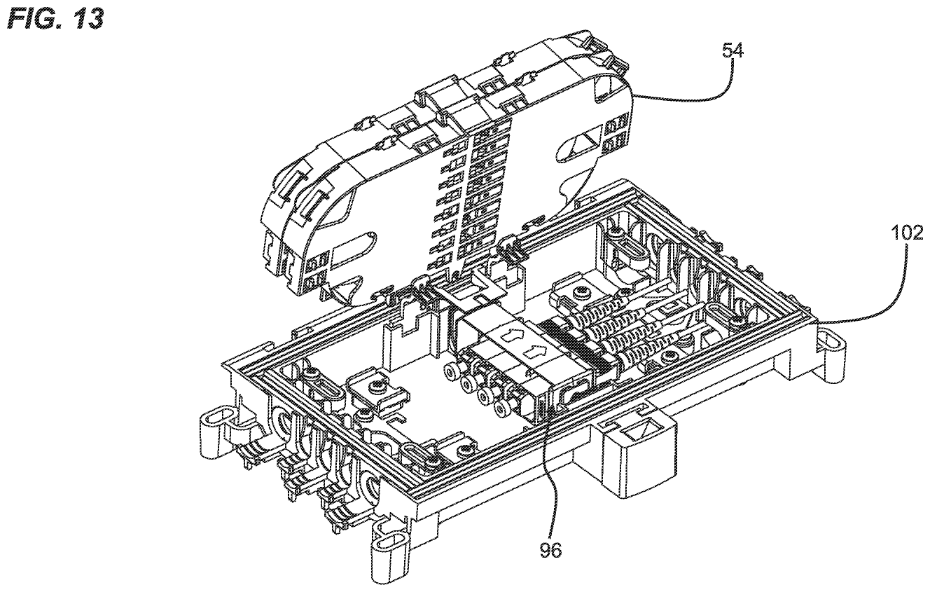

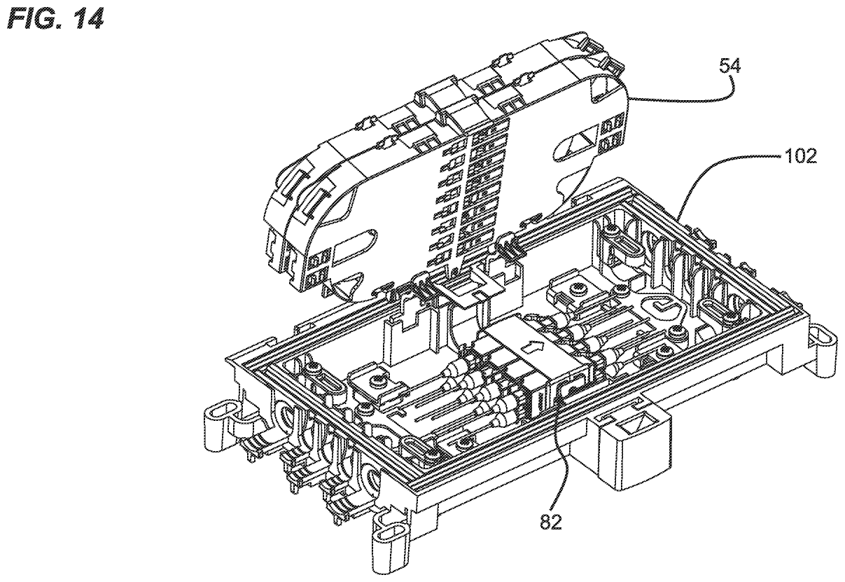

The base 102 includes structure for securing the through cable 22 or through cables to the base 102 adjacent the ports 46. Example structures can include jacket clamps 110 and strength members clamps 112. The base 102 includes structure for securing drop cables to the base 102 adjacent the ports 74. Example structures can include cable tie down locations 114 at which cables can be strapped to the base with devices such as cable ties, hose clamps, or the like. Other structures can also be incorporated in the base. For example, FIG. 12 shows a fiber management arrangement 120 including at least one spool 122 for managing excess optical fiber length and for maintaining minimum optical fiber bend radius requirement. As depicted, two spools 122 are provided for allowing optical fibers to be routed in a figure-eight configuration. FIG. 13 shows a patch location 96 having a row of SC fiber optic adapters mounted in the base. FIG. 14 shows a patch location 82 having a row of duplex adapters such as duplex LC adapters. As shown at FIGS. 12-14, the fiber management tray 54 is pivotally connected to the base and can include a stack of trays. The trays can be individually pivoted relative to one another to access each tray and the entire stack can be pivoted to access an interior of the base 102. The through cables 22 are routed under/behind the tray stack within the base. In certain examples, the cover 104 can include fiber management structures such as bend radius limiters, spools, or other fiber guides. As depicted, a spool structure 130 is provided for routing fiber in a looped configuration within the spool structure 130. A mounting structure 132 can also be provide with the cover 104 for mounting structure such as optical splices, passive optical power splitters, or fan-outs. In one example, the base can have a configuration that does not accommodate receiving and maintaining a buffer tube of the through cable in a looped configuration. An elastomeric perimeter seal is provided between the base and the cover.

In some examples, the housing 40 can have a compact configuration and at least eight of the demateable optical connection interfaces 28 with hardened exterior ports. In one example, the housing 40 can have a length equal to or less than 21 centimeters, a height equal to or less than 12 centimeters, and a depth equal to or less than 8 centimeters. In one example, the housing 40 has a two-dimensional form-factor when viewed from the front of the housing of less than or equal to 275 square centimeters or less than or equal to 250 square centimeters. In one example, the housing can define a volume of less than or equal to 2250 cubic centimeters, less than or equal to 2000 cubic centimeters, or less than or equal to 1900 cubic centimeters.

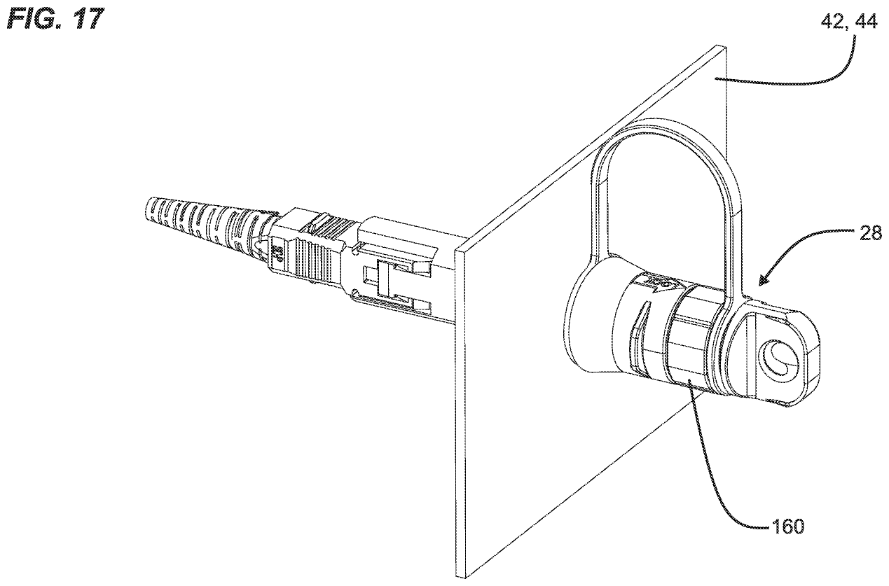

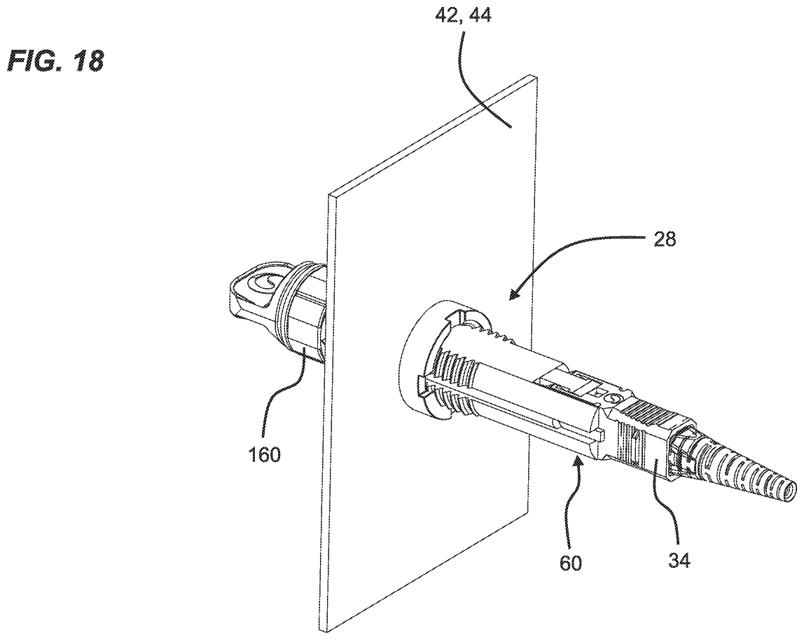

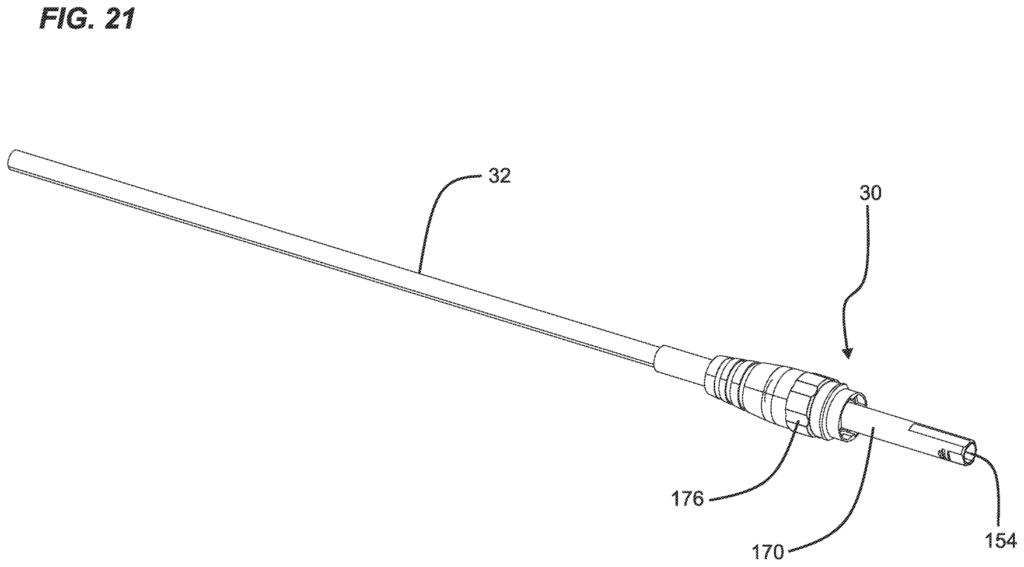

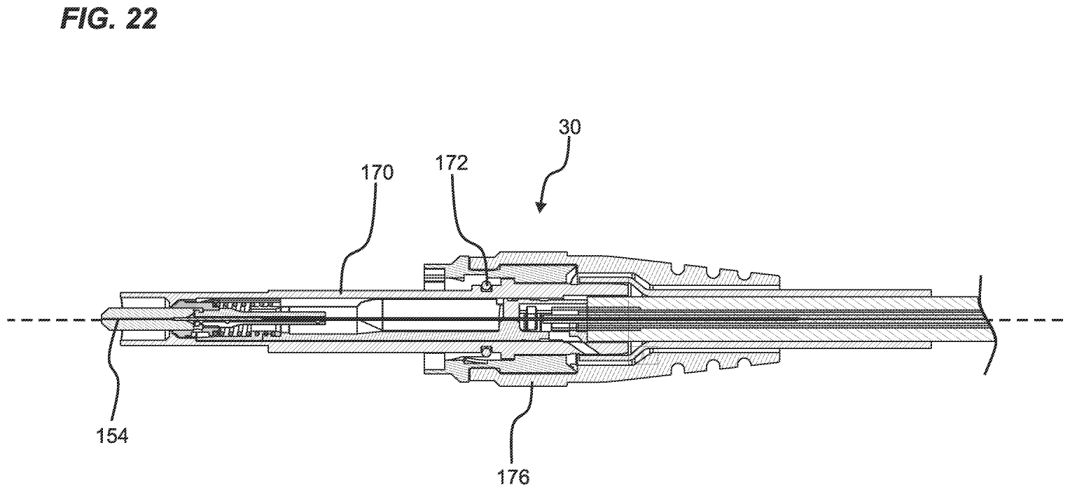

An example configuration for the demateable optical connection interfaces 28 is shown at FIGS. 17-20, and an example configuration for the hardened connector 30 is shown at FIGS. 21 and 22. Further details about the demateable optical connection interface 28 and the hardened connector 30 are provided by PCT International Publication No. WO2021/041305, which is hereby incorporated by reference in its entirety. Hardened demateable optical connection locations include seals (e.g., gasket seals such as o-ring seals) at the interface between the hardened connector and the hardened connector port. In one example, a seal can be provided at the hardened port, and a sealing surface that engages the seal can be provided at the hardened connector. In another example, a seal can be provided on the hardened connector, and a sealing surface that engages the seal can be provided at the hardened port. Hardened demateable optical connection locations have robust mechanical connections between the hardened connector and the hardened port. The mechanical connections can include twist-to secure connection (e.g., threaded connections, bayonet-style connections, other partial turn connections) and other type of connections such as latch type connections (e.g., slide latch connections as shown in U.S. Pat. No. 10,061,090, which is hereby incorporated by reference in its entirety). In one example, the fastening arrangement between a hardened connector and a hardened port is able to withstand a pull-out force of at least 25 pounds. In another example, the fastening arrangement between a hardened connector and a hardened port is able to withstand a pull-out force of at least 50 pounds.

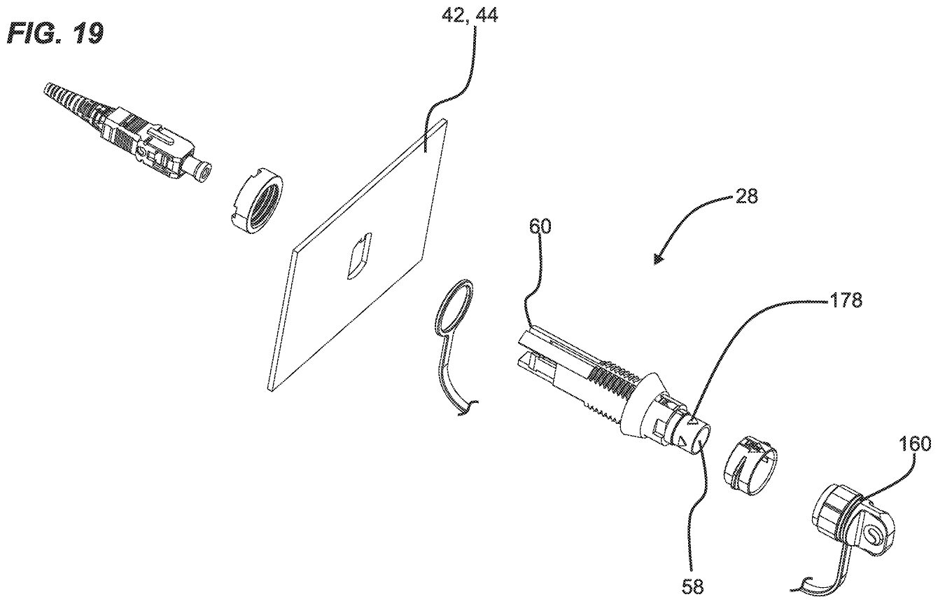

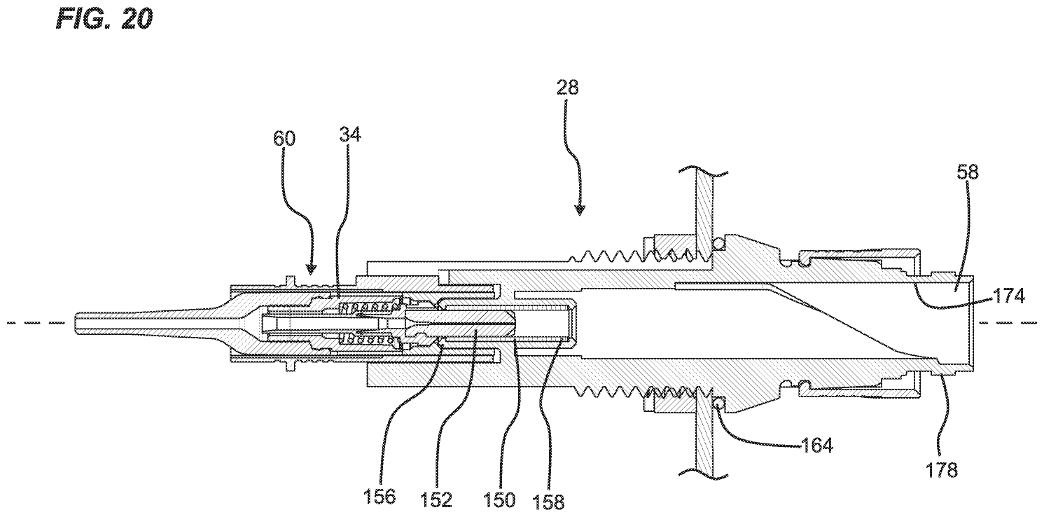

Referring to FIGS. 19 and 20, the demateable optical connection interface 28 includes the hardened connector port 58 for receiving the hardened fiber optic connector 30. The demateable optical connection interface 28 functions as a fiber optic adapter for optically connecting the inner fiber optic connector 34 to the hardened connector 30 when the hardened connector 30 is secured in the hardened external connector port 58 and the inner fiber optic connector 34 is installed at the inner connector mounting location 60. The demateable optical connection interface 28 includes a ferrule alignment sleeve 150 for aligning a ferrule 152 of the inner fiber optic connector 34 with a ferrule 154 of the hardened fiber optic connector 30. The ferrule alignment sleeve 150 includes an inner end 156 for receiving the ferrule 152 of the inner fiber optic connector 34 and an outer end 158 for receiving the ferrule 154 of the hardened fiber optic connector 30. The demateable optical connection interface 28 includes a cap/plug 160 for closing and sealing the hardened connector port 58 when the port 58 is vacant. The demateable optical connection location 28 is sealed relative to an end wall 42, 44 of the housing 40 (e.g., see sealing member 164 at FIG. 20). The hardened connector 30 includes a plug body 170 that is received in the hardened connector port 58. A seal 172 mounts on the plug body 170 for sealing against a sealing surface 174 defining the hardened port 58. The hardened connector 30 includes a fastener 176 (e.g., a partial-turn fastener such as a quarter-turn fastener) that is turnable (e.g., rotatable) relative to the plug body 170 for securing the connector within the hardened port 58. The fastener 176 is adapted to interlock with a fastening interface 178 of the demateable optical connection interface 28 to secure the hardened connector 30 within the port 58.

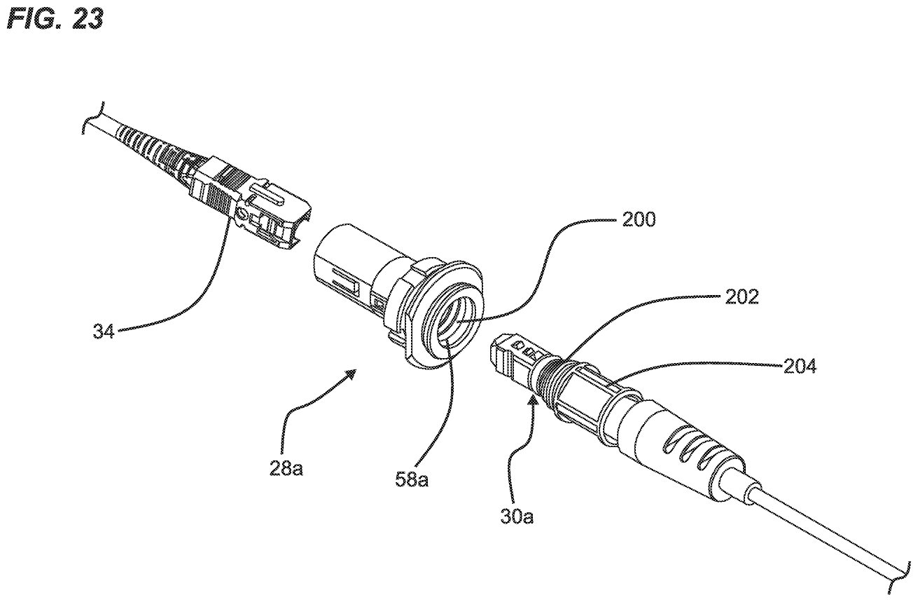

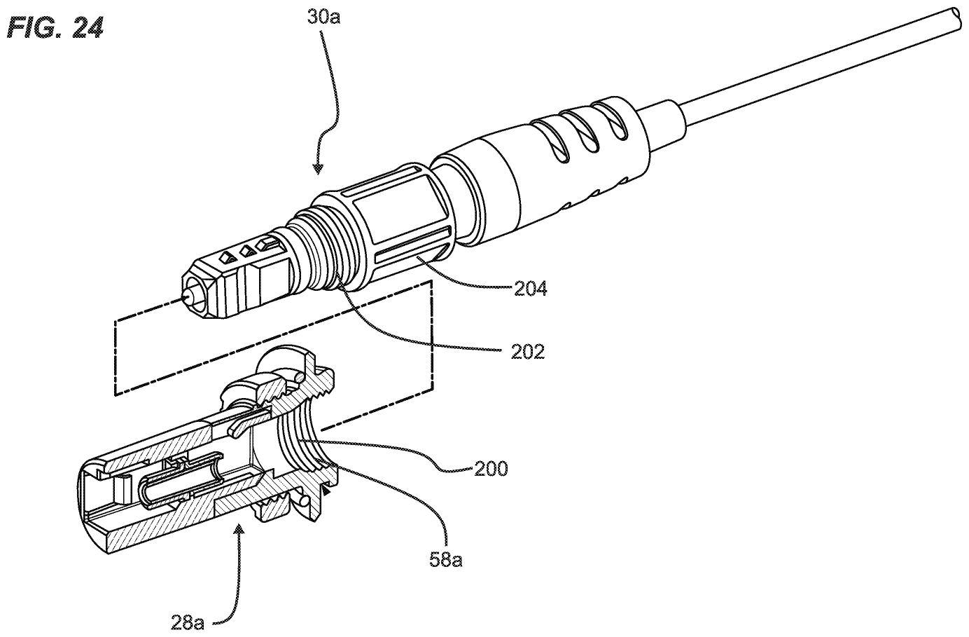

FIGS. 24 and 23 depict an alternative demateable optical connection location 28a and an alternative hardened connector 30a. The demateable optical connection location 28a includes an external port 58a with threads 200 (e.g., internal threads) for engaging threads 202 of a turnable fastener 204 of the hardened connector 30a to retain the hardened connector 30a in the port 58a. Further details about the demateable optical connection location 28a and the hardened connector 30a are provided by U.S. Pat. No. 7,744,288, which is hereby incorporated by reference in its entirety.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. A fiber optic assembly comprising:
a fiber optic cable including optical fibers that are slidable within the fiber optic cable to allow for selective retraction of the optical fibers;
a housing adapted to mount at a mid-span location of the fiber optic cable such that the fiber optic cable passes through the housing, the housing having sealed cable pass-through ports at opposite ends of the housing for receiving the fiber optic cable;
at least one fiber optic adapter carried with the housing, the fiber optic adapter including a ferrule alignment sleeve having an outer end for receiving a ferrule of a hardened connector inserted into the fiber optic adapter from outside the housing through an exterior hardened connector port; and
an inner fiber optic connector having a ferrule positioned within an inner end of the ferrule alignment sleeve, wherein the fiber optic cable is configured such that at least one optical fiber of the fiber optic cable can be cut at a cable access location outside a telecommunication enclosure, retracted back to an interior of the telecommunication enclosure, and coupled to the inner fiber optic connector.

2. The fiber optic assembly of claim 1, wherein the housing includes a cover and a base pivotally connected together at a hinge.

3. The fiber optic assembly of claim 2, wherein the housing includes a length that extends between opposite first and second ends, wherein at least one of the cable pass-through ports is provided at each of the first and second ends, and wherein at least one of the exterior hardened connector ports is provided at each of the first and second ends.

4. The fiber optic assembly of claim 3, wherein at least four of the exterior hardened connector ports are provided at each of the first and second ends.

5. The fiber optic assembly of claim 1, wherein the fiber optic cable includes at least one buffer tube, and wherein an interior of the housing is not configured to accommodate looped routing of the buffer tube in a region between the pass-through ports.

6. The fiber optic assembly of claim 1, wherein the fiber optic cable includes at least one buffer tube, and wherein an interior of the housing is not configured to accommodate looped routing of the buffer tube in a region between the pass-through ports without violating bend radius limitations of the buffer tube.

7. The fiber optic assembly of claim 1, wherein the fiber optic cable includes at least one buffer tube, and wherein an interior of the housing is not configured to accommodate looped routing of the buffer tube in a region between the pass-through ports without kinking the buffer tube.

8. The fiber optic assembly of claim 1, wherein the fiber optic cable includes at least one buffer tube, wherein the housing is installed over the fiber optic cable, and wherein the buffer tube is passed through the housing without being looped.

9. The fiber optic assembly of claim 1, wherein a depth of the cover is at least two or three times as large as a depth of the base.

10. The fiber optic assembly of claim 9, wherein the cable through ports are defined by the base and the hardened connector ports are carried with the cover.

11. The fiber optic assembly of claim 1, wherein the housing is adapted to be mounted to a façade.

12. The fiber optic assembly of claim 1, wherein a two-dimensional form-factor of the housing, when viewed from a front of the housing, is less than or equal to 275 square centimeters.
